(19) United States
(12) Patent Application Publication
(10) Pub. No.: US 2003/0119672 A1
(43) Pub. Date: Jun. 26, 2003

(54) Bioagent compositions for plant care

(75) Inventors: Henryk Struszczyk, Zgierz (PL); Antoni Niekraszewicz, Lodz (PL); Henryk Pospieszny, Poznan (PL); Alojzy Urbanowski, Lodz (PL); Maria Wisniewska-Wrona, Lodz (PL); Magdalena Kucharska, Lodz (PL)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company, Cincinnati, OH

(21) Appl. No.: 10/292,233

(22) Filed: Nov. 12, 2002

Related U.S. Application Data
(63) Continuation of application No. PCT/US01/15181, filed on May 10, 2001.

(30) Foreign Application Priority Data
May 12, 2000 (PL) P-340132

(51) Int. Cl. A01N 43/02

(52) U.S. Cl. 504/140

(57) ABSTRACT

Disclosed are bioagent compositions for plant care which can be used for treatment of plants and seeds. Such treatment serves to inhibit the activity of plant pathogens against the treated plants, stimulate natural plant immunity against such pathogens and provides plant growth biostimulation. The compositions comprise a chitosan polymer which can either be in the form of particles of microcrystalline chitosan which are in a composition of pH greater than 6.9, or in the form of a chitosan salt gel which are in a composition of pH of from 5.0 to 6.9. In either form, the chitosan polymer has specified molecular weight, polydispersity degree and degree of deacetylation characteristics. Preferably the chitosan polymer has a bimodal molecular weight distribution and contains a fraction of water-soluble oligoaminocarbohydrates. The characteristics of the chitosan polymer used in the compositions are obtained by the step-wise neutralization of, and chitosan preciptation from, acid solutions of chitosan under controlled conditions.

### CROSS REFERENCE TO PRIOR APPLICATION

This is a continuation of International Application PCT/US01/15181, with an international filing date of May 10, 2001, and published in English.

### TECHNICAL FIELD

The present invention relates to bioagent compositions for plant care. Treatment of plants with the compositions herein serves to inhibit the activity of pathogens toward the plants so treated and further stimulates the natural immunity of the treated plants against such pathogens. The compositions herein also provide growth biostimulation for plants treated therewith.

### BACKGROUND OF THE INVENTION

The publications “Experimental Mycology” Vol. 3, p.285-287, 1979; “Physiological and Molecular Plant Pathology”, Vol. 41, p.33-52, 1992; “Phytopathology”, Vol. 84, p. 312-320, 1994; “Molecular Plant-Microbe Interactions”, Vol. 7, p.531-533, 1994; “Experimental Mycology”, Vol. 8, p 276-281, 1984; and “Physiological Plant Pathology”, Vol. 20, p. 119-123, 1982 all disclose the application of chitosan to plants as an elicitor or agent protecting plants against fungal diseases like Fusarium solani, Capsicum annum, Catharanthus roseus, and Aphanomyces enteiches. In these applications, the chitosan is used in aqueous solutions, chiefly in organic acids. Such known chitosan-based agents may, as a consequence of their formulation, show phytotoxic action toward plants. Furthermore such formulations act insufficiently on fungal diseases in vivo. Given their form, such preparations selectively act on pathogenic fungi and do not display a controlled action on fungi in vivo without the possibility of simultaneously affecting various fungi strains.

Polish Patent Applications P.324094 and P.324095 both disclose bioagents for protecting plants against, respectively, bacterial and fungal diseases. The bioagents disclosed in these patent applications are water suspensions of microcrystalline chitosan containing 0.001-10% of microcrystalline chitosan with average molecular weight, respectively, of not less than 20 kD (P.324094) and 1 kD (P.324095); a water retention value (WRV) of not less than 100%, a deacetylation degree of not less than 65%, and an average particle size in the 1-100 μm range. These bioagents actively inhibit the development of bacterial and fungal pathogens which appear in the soil and/or on the plant by directly affecting the pathogens and promoting natural plant immunity. Since these bioagents are in the form of suspensions, these agents find only limited application possibilities and, due to the particle size of the chitosan therein, their plant protection potential is limited.

Polish Patent Applications P.269 984 and P.269 985 both disclose methods for limiting the infection caused by plant viruses. In such methods, plants, prior to infection with mechanically transmitted viruses, are treated with chitosan having an average molecular weight of 5-200 kD. The chitosan is in the form of either solutions in organic acids with a polymer concentration of 0.005-0.1% or suspensions of microcrystalline chitosan in water or organic fluids containing 0.005-0.01% of the polymer which has a water retention value of 100-500%. The use of chitosan solutions in organic acids is not convenient because of the acidity and phytotoxicity toward plants and because is is not easy to remove the preparate with water. The use of microcrystalline chitosan is limited with respect to the suspension form and particle size.

Polish Patent Application P.335454 discloses an agent for protecting plants against bacterial, fungal and viral diseases. This agent comprises a chitosan gel with a pH in the range 6.3 to 7.0, containing not less than 0.001% chitosan having an average molecular weight not lower than 10 kD preferably 20-500 kD and deacetylation degree not lower than 65% preferably 70-95%. The preparate demonstrates biological activity in inhibiting pathogens. The agent can additionally contain some water-soluble polymers which facilitate the deposition of the agent on plants.

U.S. Pat. No. 5,726,123 discloses a method to enhance the crop output of plants by applying an aqueous acidic solution of mixture of chitosan salts and added chitosan oligomers. U.S. Pat. No. 4,886,541 discloses a method for encapsulating grain seeds with chitosan salts to promote better plant rooting and increase of stem diameter. U.S. Pat. No. 4,964,894 discloses a plant growth regulator based on an aqueous acidic solution of chitosan salts or dry chitosan salts to be applied in the soil. U.S. Pat. No. 5,965,545 discloses a composition and a method for controlling the growth of fungal pathogens. Such a composition and method utilize a mixture of an aqueous, acidic or close to neutral solutions of chitosan salts with average molecular weight 200 kD and added oligoaminocarbohydrates with an average molecular weight in the 4-10 kD range.

All of these known chitosan-based agents fail to demonstrate an optimal biological activity in protecting plants against pathogens like fungi, bacteria, and viruses. Furthermore they do not exhibit a wide spectrum in plant care that would stimulate the growth of plants from germination to harvest. The application of acidic aqueous solutions of chitosan in the known methods causes phytotoxic action on the plant and facilitates the removal of salts by water.

The publication in “Plant Cells”, Vol. 8, p. 629-648, 1996 discloses an agent which is based on benzothiadiazole and which has with the tradename “Bion”. This agent acts as a systemic immunity inductor for plants. It mobilizes the natural defense mechanism and enhances immunity by acting similarly as the preventive vaccination for humans. The agent is, however, inactive during the first period after application and the duration of the induction period depends upon the plant type and applied dose.

### SUMMARY OF THE INVENTION

The present invention provides bioagent compositions useful for plant care. Such compositions can be in liquid or solid state. The compositions herein comprise at least 0.001%, and preferably 0.1% to 99.9%, by weight of chitosan polymer in certain forms and having certain chemical characteristics.

In one embodiment, the chitosan polymer is utilized in the compositions in the form of particles of “microcrystalline” chitosan. Such particles are in the composition which has a pH of greater than 6.9. Microcrystalline chitosan particles of this type are those which have been prepared by a specific step-wise precipitation from aqueous acidic solutions of chitosan.

In another embodiment, the chitosan polymer is utilized in the compositions herein as a gel-form chitosan salt which are in a composition having a pH of from 5.0 to 6.9. Such gel-from chitosan salts can also be prepared by a specific step-wise precipitation process.

No matter which form of chitosan polymer is utilized, the chitosan polymer present in the compositions must have an average molecular weight of not less than 10 kD, a polydispersity degree not lower than 2 and a deacetylation degree not lower than 65%. Preferably the chitosan polymer has a bimodal distribution of molecular weight and comprises a fraction of water-soluble oligoaminocarbohydrates having an average molecular weight less than 10 kD.

### DETAILED DESCRIPTION OF THE INVENTION

As noted, the chitosan component of the compositions herein is present in certain specific forms which generally result from the way in which the chitosan polymer is prepared. Such forms are those which are realized when the chitosan is precipitated from aqueous acidic chitosan solutions via a procedure involving the step-wise addition of neutralizing agent to such acidic solutions under shear agitation. Such a procedure is disclosed in Polish Patent Application No. P.340132 and in the concurrently filed PCT Application No. US/01/87988 (P&G Case CM-2550FL*).

One such specific form of chitosan useful in the bioagent compositions herein is characterized as “microcrystalline chitosan” or “MCCh.” The process for preparing MCCh involves several steps.

In the first step of the process for preparing MCCh, an aqueous solution is formed, generally containing at least 0.001% and preferably from 0.01% to 10.0% by weight of chitosan which can be provided by any conventional chitosan source. This solution contains organic or inorganic acids and/or salts of such acids in an amount sufficient to maintain the solution at a pH which is low enough to completely solubilize the chitosan.

In the next step of the MCCh preparaation process, the aqueous solution of the first step is partially neutralized by adding a neutralizing agent while subjecting the solution to shear agitation. The neutralizing agent addition and the agitation are sufficient to convert the solution into a continuous gel phase having a pH of from 5.0 to 6.9

In the next process step for preparing MCCh, the partially neutralized gel formed in the previous step is maintained under shear agitation for at least 10 seconds after the gel phase has been formed in order to homogenize the gel phase. This agitated homogenized gel is then further neutralized under continuing agitation by addition of more neutralizing agent sufficient to raise the pH within the homogenized gel phase to above 6.9, preferably above 7.3. Agitation is preferably continued for at least another 10 seconds after this elevated pH is reached. This then forms a gel-like suspension of discrete particles of MCCh, and it is this gel-like suspension which can be used as the chitosan component of the bioagent compositions herein.

The chitosan particles used in this particular embodiment of the compositons herein are characterized as “microcrystalline” even though their degree of crystallinity is very low, and, in fact is much lower than the degree of crystallinity of many commercially available chitosan products which have a significant crystalline content. Perhaps more accurately, the particles herein can be characterized as “activated” given their utility in the bioagent compositions herein. The chitosan material of the particles which are produced is activated because it has a modified specific molecular structure having specific molecular weight and degree of polydispersity. It also has a supermolecular structure having certain morphological characteristics which provide porosity and ability to retain water in a capillary system. Thus for purposes of this invention, “microcrystalline” chitosan (MCCh) particles are those which have been modified by their prepration process to be “activated.”

In the compositions herein, the chitosan polymer component may also be utilized as a gel-form chitosan salt. Chitosan salts in gel form may also be produced by the process described above but one in which the final neutralization step is not used. Thus in the process described above, the homogenized continuous gel phase having a pH of from 5.0 to 6.9 is, in fact, a material which may also be used in the compositions herein without further converting this homogenized gel phase material to MCCh.

No matter which form of chitosan is used, the chitosan in the compositions herein preferably have a molecular weight of from 15 to 1300 kD. The chitosan polymer will also preferably have a polydispersity degree of from 3 to 6. Finally the chitosan polymer will also preferably have a deacetylation degree of from 75% to 95%.

In either microcrystalline or gel form, the chitosan polymer such as prepared by the process steps outlined above may have a bimodal distribution of molecular weight. The chitosan polymer prepared in the manner outlined above will generally also have a water-soluble fraction of oligomeric aminocarbohydrates within its polymeric structure. Such an oligomeric fraction will preferably have an average molecular weight within the range of from 0.179 to 1.79 kD.

The advantage of the bioagent compositions herein resides in their use of chitosan of controlled structure, especially a structure having the distribution of molecular weight with bimodal character and/or the presence of the oligomeric fraction. These features provide the multifunctional activity in inhibiting plant pathogens such as viruses, viroids, bacteria and fungi, both directly and indirectly, and a simultaneous stimulation of natural plant immunity against these pathogens. Furthermore, the bioagent compositions herein, both those using chitosan in the form of microcrystalline chitosan as well as those using gel chitosan salts, cause a biostimulation of plant growth from seed germination through seedlings up to the final form of plant or fruits. The joint action of the bioagent composition according to the present invention provides the desirable plant care activity.

The structure of chitosan bioagent allows, among other things, a controlled biodegradation of chitosan after its application as consequence of the presence of microorganisms or enzymes. Such biodegradation produces a suitable amount and types of bioactive oligoaminosaccharides which inhibit the growth of bacteria or fungi and also biostimulates the plants during their growth stages. The molecular structure of the chitosan bioagent as polycationic provides a controlled, optimal effect against several fungi and also beneficially affects membranes of plants causing the stimulation of natural immunity to pathogens.

The advantage of bioagent is its immediate action after its use, both in the inhibition of the disease pathogens as well as the stimulation of natural plant immunity and growth biostimulation. Another advantage of the chitosan bioagent, both in microcrystalline chitosan form and as gel-form chitosan salts, is the long lasting effect of its use under changeable atmospheric conditions. These forms of chitosan protects the plants in homes as well as in gardens and fields.

Yet another advantage of the active bioagent chitosan used in the compositions herein is the high immunity imparted to the treated plants, even when used at concentrations as low as 0.001% wt. The chitosan material also has a wide application range without any hazard for the environment, humans or other animals. The chitosan bioagent, in fact, permits the entire elimination of environmental pollution due to its natural origin and complete biodegradability. The plants and their fruits can be used shortly after the bioagent application without the risk of harmful residues.

The chitosan bioagent used in this the invention exhibits higher biological activity toward the treated plants, both in terms of protection and biostimulation, than do other known chitosan based agents. The bioactivity of this chitosan bioagent stems from its controlled structure and its in situ reactions which prevent phytotoxic effects in plants.

The present invention is illustrated by the following examples which are not meant to limit the scope of the invention:

### EXAMPLE I

Microcrystalline chitosan (MCCh) in a form of gel-like dispersion containing 0.94 wt % of polymer is used for plant care of the Nochowska variety of lettuce. The MCCh 25 polymer used is characterized by an average molecular weight \overline{M}v=488.9 kD, polydispersity degree Pd=4.53, bimodal molecular weight distribution with maxima at 60.9 kD and 169.8 kD, the presence of 0.95 wt % of an oligomeric fraction with average molecular weight 1.2 kD resulting from the manufacture of MCCh, deacetylation degree DD=80.6%, water retention value WRV=4500% and pH=7.1.

The MCCh-containing composition is used in the stages of seed germination, plant growth as well as lettuce protection. The lettuce seeds are germinated in an aqueous dispersion of MCCh with differing concentrations for 3 days at 20° C. The results of the germination test are presented in Table 1.

TABLE 1

| MCCh concentration | Roots weight |
|---|---|
| (wt %) | percent compared to control |
| 0.01 | 150 |
| 0.1 | 128 |
| 0.5 | 113 |

The soil used for lettuce seed germination is inoculated with fungi from the Botrytis cinerea strain. The lettuce seeds are encrusted with a 0.1 wt % dispersion of MCCh and then dried at 35° C. These seeds are then introduced into the infected soil, and the germination power is estimated after 5 days, in comparison to unencrusted seeds placed in the same soil and used as a control. The MCCh-treated seeds provided a 90% germination power whereas the control provided only 30%.

MCCh is introduced by mixing and spraying into a soil sample comprising a mixture of deacidified peat and sand in a weight ratio of 1:1. Lettuce seeds are then sown in such soil. The biostimulation of plant growth in the greenhouse is estimated after 3 weeks. The results of such a test are presented in Table 2.

TABLE 2

| MCCh concentration in soil | Growth biostimulation |
|---|---|
| (wt %) | (% in comparison to control) |
| 0.1 | 112 |
| 0.3 | 115 |

MCCh at a concentration of 0.001 wt % is used for spraying the lettuce 6 days before inoculation of the lettuce with the AIMV viruses. Such spraying inhibits the viruses' growth in 99.5% of the lettuce. MCCh is used in vitro for inhibition of Clavibacter michiganense. In such testing MCCh provides a minimum inhibiting concentration (MIC) equal to 0.5. This testing shows that MCCh used for lettuce plant care does not cause any phytotoxic effect. This MCCH bioagent is excellent for care of lettuce plants during their growth period.

### EXAMPLE II

Microcrystalline chitosan (MCCh) in a gel-like suspension with 2.8% content of the polymer is used for plant care of the tomato species “Slonka”. The MCCh in the suspension is characterized by an average molecular weight \overline{M}ᵥ=149 kD, a polydispersity degree Pd=5.12 and a bimodal distribution of the molecular weight with maxima at 38.5 kD and 120 kD, a 1.45% content of an oligomeric fraction with an average molecular weight of 1.5 kD resulting from the manufacture of the MCCh, a deacetylation degree DD=86.4%, a water retention value WRV=1950% and pH=7.0.

MCCh is used for incrusting the tomato seeds; it is also applied on roots of seedlings and sprayed on the plants during growth. The seeds are immersed for one hour in MCCh suspensions with different polymer concentrations and then dried afterwards. The incrusted seeds are put into to a soil as in Example I, and the power of germination is estimated. The results of germination are presented in Table 3.

TABLE 3

| Concentration of MCCh for | |
|---|---|
| incrusting | Power of Germination |
| (wt %) | (%) |
| 0 (control) | 92 |
| 0.01 | 98 |
| 0.1 | 97 |
| 0.5 | 95 |

Before out-bedding, the roots of the seedlings are immersed for 5 minutes in MCCh suspensions at various concentrations of MCCh. They are next bedded out in soil as in Example I. After two weeks growth in green-house, the roots and the green mass are weighed. The results are given in Table 4.

TABLE 4

| | |
|---|---|
| Concentration of | Weight |
| MCCh | (% compared to control) |

| (wt %) | Roots | Green mass |
|---|---|---|
| 0.1 | 150 | 125 |
| 0.5 | 200 | 158 |

During growth, the tomato roots are 3 times sprayed in 2-week intervals with MCCh suspensions with varied concentration. The results of the resulting biostimulation, estimated as growth rate of the fruit harvest, are given in Table 5.

TABLE 5

| Concentration of MCCh used for | |
|---|---|
| spraying | Fruit Harvest |
| (wt %) | (% compared to control) |
| 0.05 | 109 |
| 0.1 | 124 |
| 0.5 | 119 |

During growth, the tomato plants are sprayed with a gel-like suspension of MCCh and with a suspension of solid MCCh with varied concentration and after 24 hours inoculated with tobacco mosaic AIMV virus. The results of the inhibition of infection are shown in Table 6.

TABLE 6

| | | Inhibition of |
|---|---|---|
| | Concentration of MCCh | infection |
| Kind of MCCh | (wt %) | (%) |
| Gel-like MCCh | 0.01 | 93.6 |
| Suspension | | |
| | 0.1 | 99.3 |
| Suspension of MCCh | 0.01 | 82.5 |
| powder | | |
| | 0.1 | 99.5 |

During growth, the tomato plants are sprayed with gel-like MCCh suspension with varied concentration 5, 24 and 48 hours before the plants are inoculated with bacteria Pseudomonas syringae pv tomato. The results of the inhibition of infection testing are presented in Table 7.

TABLE 7

| | Concentration of | |
|---|---|---|
| Time between spray | MCCh | Inhibition of infection |
| and inoculation hours | (wt %) | (%) |
| 48 | 0.2 | 60 |
| | 0.1 | 60 |
| | 0.05 | 50 |
| | 0.01 | 45 |
| 24 | 0.2 | 70 |
| | 0.1 | 70 |
| | 0.05 | 55 |
| | 0.01 | 50 |
| 5 | 0.2 | 70 |
| | 0.1 | 70 |
| | 0.05 | 60 |
| | 0.01 | 50 |

The MCCh used for tomato plant care does not cause any phytotoxic effect. It is an ideal bioagent for plant care during the growth period. The harvested fruits are in excellent health condition.

### EXAMPLE III

The gel form of chitosan lactate is used for plant care of Nochowska variant lettuce plants. This gel form contains 1.6% of a polymer characterized by Mv=70 kD, Pd=3.98, bimodal distribution of molecular weight with maxima at 15.8 kD and 51.0 kD, containing 3.8 wt % of an oligomeric fraction obtained during the preparation of the gel with average molecular weight 2.8 kD, a deacetylation degree DD=87.6% and pH=6.71. The gel form is used during seed germination, plant growth as well as for plant protection. The lettuce seeds are germinated in aqueous solutions of gel form of chitosan with different polymer concentrations during 3 days at 20° C. The results are presented in Table 8.

TABLE 8

| Polymer concentration | Roots weight |
|---|---|
| (wt %) | (% in comparison to control) |
| 0.01 | 148 |
| 0.1 | 138 |
| 0.5 | 115 |

This gel form of chitosan is introduced to the soil as in Example I. The biostimulation effect related to the weight of plants, in comparison to control, is estimated. The results of such testing are shown in Table 9.

TABLE 9

| Polymer concentration in soil | Biostimulation of growth |
|---|---|
| (wt %) | (% in comparison to control) |
| 0.1 | 125 |
| 0.3 | 130 |

This gel form of chitosan, with concentration of 0.01 and 0.001 wt %, is used for plant dressing 24 hours before the plants are inoculated with AIMV viruses. This gel form inhibits the virus infection to the extent of 99.5% and 98.8% respectively.

This gel form of chitosan lactate is used for the growth inhibition of Botrytis cinerea fungi using media rich in PDA components and poor media-SNA. At a concentration of 5 mg/cm^{3,} a 100% growth inhibition of this fungus is acheived.

The gel form of chitosan lactate does not cause any phytotoxic effect at any stage of the lettuce growth. This bioagent is an excellent agent for plant care.

### EXAMPLE IV

A gel form of chitosan acetate is used for the plant care of the tomato species “Stonka”. Such gel form of chitosan acetate contains 1.3 wt % of polymer characterized by Mᵥ=150 kD, polydispersity degree Pd=4.68, a bimodal distribution of molecular weight with maxima at 48.3 and 120.5 kD, a 2.5 wt % content obtained during the manufacture of the gel form of an oligomeric fraction with average molecular weight 3.2 kD, a deacetylation degree DD=73.4% and pH=6.50. The tomato seedlings before bed-out are immersed for 5 minutes in suspensions of this gel-like form of chitosan salt. They are next out-bedded in soil as in Example I. After 2 weeks growth in green house, the weight of roots and green mass is estimated. Results are presented in Table 10.

TABLE 10

| | Weight |
|---|---|
| Content of chitosan | (% compared to control) |

| (wt %) | Roots | Green mass |
|---|---|---|
| 0.1 | 210 | 144 |
| 0.5 | 105 | 100 |

During growth the tomato plants are sprayed with this gel form of chitosan salt at two concentrations. After 24 hours the plants are inoculated with tobacco mosaic virus AIMV. Results are presented in Table 11.

TABLE 11

| Concentration of chitosan | Inhibition of infection |
|---|---|
| (wt %) | (%) |
| 0.01 | 95.8 |
| 0.1 | 100.0 |

A gel form of chitosan salt with 0.1 wt % concentration is tested in vitro for its ability to inhibit the growth of Botrytis cinerea fungus. 80% and 85% inhibition of the fungus growth was attained for the rich PDA and weak SNA media respectively. The gel form of chitosan acetate used for tomato plant care does not cause any phytotoxic effect. It is an ideal bioagent for plant care during the growth period. The fruits which are obtained are in very good health condition.

### EXAMPLE V

The influence of an MCCh suspension of the type described in Examples I and II and the gel form of chitosan salt of the type described in Examples m and IV on the germination of flax seeds and rooting of strawberry seedlings is estimated. The flax seeds are placed on Petri plates lined with tissue paper disks (10 cm diameter) saturated with aqueous suspensions or solutions of the chitosan. After 3 days of germination at 20° C., the root length, as an average, from two tests is estimated. The results obtained for flax are presented in Table 12.

TABLE 12

| | | Concentration of | |
|---|---|---|---|
| | | chitosan | Length of roots |
| Kind of seed | Form of chitosan | (wt %) | (% vs. Control) |
| Flax | MCCh | 0.5 | 153 |
| | \overline{M}ᵥ = 149 kD | 0.1 | 141 |
| | | 0.05 | 111 |
| | Gel | 0.5 | 142 |
| | \overline{M}ᵥ = 70 kD | 0.1 | 115 |
| | | 0.05 | 108 |

The strawberry seedlings before planting are treated for 2 hours with MCCh suspension or chitosan solution. After 2 weeks, the weight of roots is estimated. Results for strawberries are presented in Table 13.

TABLE 13

| | Concentration of | |
|---|---|---|
| | chitosan | Weight of roots |
| From of chitosan | (wt %) | (% vs. Control) |
| MCCh | 0.1 | 207 |
| \overline{M}ᵥ = 488.9 kD | | |
| Gel | 0.1 | 160 |
| \overline{M}ᵥ = 150.0 kD | | |

What is claimed is:

1. A bioagent composition for plant care, which composition is in liquid or solid state and which comprises at least 0.00 1% by weight of chitosan polymer, wherein said chitosan polymer is in a form selected from:
A) particles of microcrystalline chitosan at a composition pH of greater than 6.9; and
B) gel-form chitosan salt at a composition pH of from 5.0 to 6.9;
wherein said chitosan polymer has an average molecular weight of not less than 10 kD, a polydispersity degree not lower than 2 and a deacetylation degree not lower than 65%.

2. A bioagent composition according to claim 1 comprising from 0.1% to 99.9%, by weight of said chitosan polymer.

3. A bioagent composition according to claim 1 wherein the chitosan polymer has an average molecular weight of from 15 to 1300 kD, a polydispersity degree of from 3 to 6, and a deacetylation degree of from 75% to 95%.

4. A bioagent composition according to claim 3 wherein the chitosan polymer has a bimodal distribution of molecular weight.

5. A bioagent composition according to claim 1 wherein the chitosan polymer comprises a fraction of water-soluble oligoaminocarbohydrates having an average molecular weight less than 10 kD.

6. A bioagent composition according to claim 5 wherein said water-soluble oligoaminocarbohydrates has an average molecular weight of from 0.179 to 1.79 kD.

7. A bioagent composition according to claim 1 wherein said chitosan polymer comprises a gel-like suspension of microcrystalline chitosan particles, which suspension is prepared by:
A) forming an aqueous solution containing at least 0.001% by weight of chitosan, which solution further contains organic or inorganic acids or salts of said acids in an amount sufficient to maintain said solution at a pH which is low enough to completely dissolve said chitosan;
B) partially neutralizing said aqueous solution by adding a neutralizing agent while subjecting said aqueous solution to shear agitation, which neutralizing agent addition and agitation is sufficient to convert said solution into a continuous gel phase having a pH of from 5.0 to 6.9;
C) maintaining the neutralized gel formed in Step B) under shear agitation for a period of at least 10 seconds after said gel has been formed in order to homogenize said gel phase; and subsequently
D) further neutralizing said homogenized gel phase formed in Step C) by addition of additional neutralizing agent sufficient to raise the pH within said homogenized gel phase above 6.9, with continued shear agitation to an extent which is sufficient to form said gel-like suspension of discrete particles of microcrystalline chitosan.

8. A bioagent composition according to claim 7 wherein the addition of additional neutralizing agent in Step D) is sufficient to raise the pH within said homogenized gel phase above 7.3.

9. A bioagent composition according to claim 7 wherein said gel-like suspension of microcrystalline chitosan particles is utilized at a composition pH of from 7.0 to 7.2.

10. A bioagent composition according to claim 1 wherein said chitosan polymer comprises a gel-form chitosan salt, which salt is prepared by:
A) forming an aqueous solution containing at least 0.001% by weight of chitosan, which solution further contains organic or inorganic acids or salts of said acids in an amount sufficient to maintain said solution at a pH which is low enough to completely dissolve said chitosan;
B) partially neutralizing said aqueous solution by adding a chitosan salt-forming neutralizing agent while subjecting said aqueous solution to shear agitation, which neutralizing agent addition and agitation is sufficient to convert said solution into a continuous gel phase having a pH of from 5.0 to 6.9; and
C) maintaining the neutralized gel formed in Step B) under shear agitation for a period of at least 10 seconds after said gel has been formed in order to homogenize said gel phase and to thereby form a homongenized gel phase containing said chitosan salt.
